(19) United States
(12) Patent Application Publication
(10) Pub. No.: US 2008/0160966 A1
(43) Pub. Date: Jul. 3, 2008

(54) SERVICE ZONES FOR PROVIDING LOCATION-BASED SERVICES IN A WIRELESS NETWORK

(76) Inventors: Kevin W. McKiou, Naperville, IL (US); Arun Sankisa, Chicago, IL (US)

Correspondence Address: DUFT BORNSEN & FISHMAN, LLP, 1526 SPRUCE STREET, SUITE 302, BOULDER, CO, 80302, US

(21) Appl. No.: 11/617,148

(22) Filed: Dec. 28, 2006

(51) Int. Cl. H04M 3/42; H04Q 7/20

(52) U.S. Cl. 455/414.1; 455/41.2; 455/456.3

(57) ABSTRACT

Systems and methods are provided for defining a plurality of services zones within a wireless network and providing common content to users located within a particular service zone. The method comprises defining a plurality of service zones within the wireless network. The service zones are defined for providing location-based services to users within the service zones. The method further comprises identifying common content for a service zone. The method further comprises transmitting the common content to communication devices of a plurality of users located within the service zone.

### RELATED APPLICATIONS

This patent application is related to a co-pending patent application having the Ser. No. 10/953,740, filed on Sep. 29, 2004, which is incorporated herein by reference. This patent application is also related to a co-pending patent application having the Ser. No. 11/317,144, filed on Dec. 23, 2005, which is incorporated herein by reference.

### BACKGROUND OF THE INVENTION

1. Field of the Invention

The invention is related to the field of communications, and in particular, to providing location-based services to mobile users of a wireless network. More particularly, the location-based services described herein allow a wireless network to provide common content to a plurality of users within a predefined service zone of the wireless network.

2. Statement of the Problem

Cellular phones, PCS phones, and other mobile wireless data devices have become very popular due to the conveniences that they provide to people. Wireless devices have become compact in size, which make them easy and convenient to carry. People routinely carry their cell phones or wireless PDAs with them on their belt, in their pocket, in their purse, etc., so they are available for use at any time.

Because of the large demand for wireless voice and data services, service providers strive to offer new services to current and potential customers. Some exemplary services are text messaging, digital pictures, web browsing, etc. A new trend for service providers is to provide location-based services. The location-based services provide information to a user based on the location of the user. For instance, the location-based services may send informational text messages to the user's phone, such as information on the weather, information on traffic reports, advertisements, etc., based on the location of the user. Another location-based service allows a user to identify and/or communicate with other individuals, groups and businesses in his/her vicinity or another geographic area.

One problem with present location-based services is determining which content to provide to users, because the determination needs to be made on a user by user basis. Take for example the scenario where a user is provided with a list of individuals, groups and businesses within a half-mile radius of the user's present location. The wireless network needs to determine the user's location, and then generate a corresponding list of individuals, groups and businesses for the user. The network needs to compare the user's location with all of the individuals, groups and businesses on the wireless network to determine which are located within the user's vicinity. This process needs to be repeated for every user of the network. For a large network with thousands or millions of users, the processing needed to determine the content for each user may place a large burden on the network. Thus, it would be desirable to identify location-based services content for users in a more efficient manner.

### SUMMARY OF THE SOLUTION

The invention solves the above problems and other problems by defining a plurality of service zones within a wireless network for providing location-based services and for providing common content to users located within a particular service zone. Advantageously, the wireless network no longer needs to maintain and generate separate content for each user of the wireless network. Rather, the wireless network only needs to generate common content for each service zone, and provide the common content to the users located within the corresponding service zone. This saves processing time and resources in the generation of the location-based services as well as bandwidth savings, because content may now be broadcast to groups of users rather than transmitting individualized content to each individual user.

A first exemplary embodiment of the invention comprises a method for providing location-based services on a wireless network. The method comprises defining a plurality of service zones within the wireless network. The service zones are defined for providing location-based services to users within the service zones. The method further comprises identifying common content for a service zone. For instance, the common content may be a list of users within the service zone that are available for communication or a list of services available within the service zone. The method further comprises transmitting the common content to communication devices of the users located within the service zone. Thus, each communication device within a particular service zone receives the same common content.

A second exemplary embodiment of the invention comprises a system for providing location-based services on a wireless network. The system comprises a management system adapted to define a plurality of service zones within the wireless network. The system also comprises a content manager adapted to identify common content for a service zone. The system also comprises a transmission system adapted to transmit the common content to communication devices of users located within the service zone.

A third exemplary embodiment of the invention comprises another method for providing location-based services on a wireless network. The method comprises defiling a plurality of service zones within the network. The method further comprises determining active service zones to provide location-based services that include a group of users located within the service zone that are provided with location-based services for the service zone. The method further comprises identifying the users within each of the active service zones. The method further comprises generating common content for each of the active service zones, wherein the common content for the active service zone comprises information of the users located with the active service zone. The method further comprises broadcasting the common content for each the active service zones.

The invention may include other exemplary embodiments described below.

### DESCRIPTION OF THE DRAWINGS

The same reference number represents the same element or same type of element on all drawings.

FIG. 1 illustrates a coverage area of a wireless network including a plurality of service zones for providing location-based services in an exemplary embodiment of the invention.

FIG. 2 illustrates a service zone of the coverage area of FIG. 1 in an exemplary embodiment of the invention.

FIG. 3 illustrates a wireless network for providing location-based services in an exemplary embodiment of the invention.

FIG. 4 is a flow chart illustrating a method of operating a wireless network to provide location-based services in an exemplary embodiment of the invention.

FIG. 5 illustrates an exemplary screen displayed by a communication device in implementing the location-based services described herein.

FIG. 6 is a flow chart illustrating a method of operating a wireless network to provide location-based services in an exemplary embodiment of the invention.

FIG. 7 is a flow chart illustrating a method of operating a wireless network to provide location-based services in an exemplary embodiment of the invention.

FIG. 8 illustrates a coverage area of a wireless network including a plurality of service zones in another exemplary embodiment of the invention.

FIGS. 9-11 are flow charts illustrating methods of operating a wireless network to provide location-based services in exemplary embodiments of the invention.

FIGS. 12-13 illustrate exemplary screens displayed by a communication device in implementing the location-based services described herein.

FIG. 14 is a flow chart illustrating a method of operating a wireless network to provide location-based services in another exemplary embodiment of the invention.

### DETAILED DESCRIPTION OF THE INVENTION

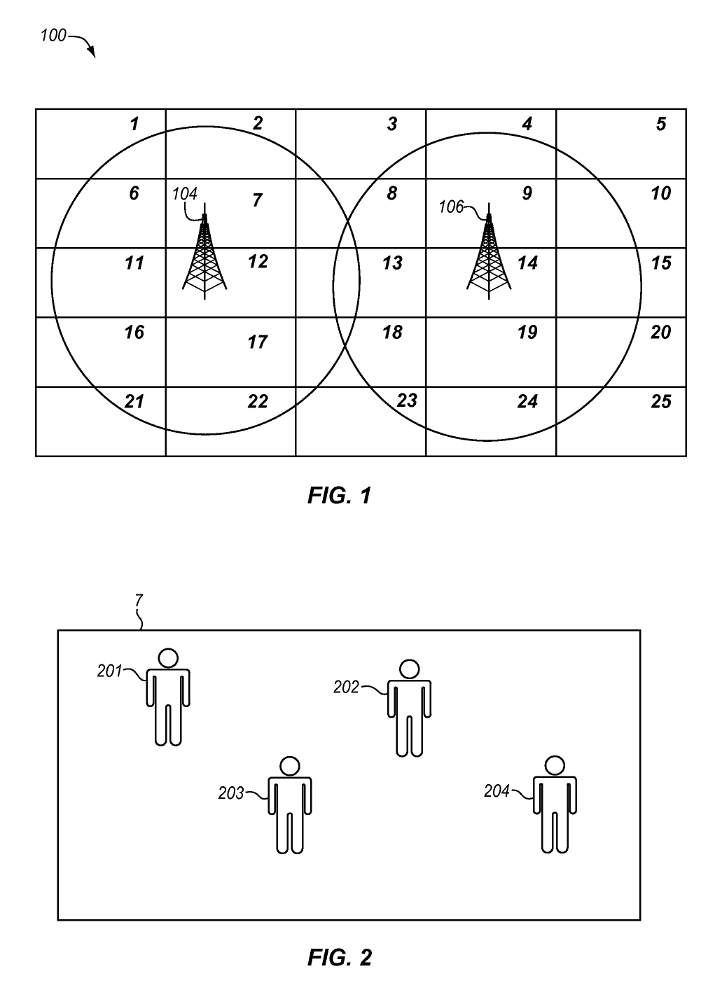

FIGS. 1-14 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below may be combined in various ways to form multiple variations of the invention. As a result, the invention is not limited to the specific embodiments described below, but only by the claims and their equivalents.

FIG. 1 illustrates a coverage area 100 of a wireless network including a plurality of service zones 1-25 for providing location-based services in an exemplary embodiment of the invention. The wireless network comprises any wireless network for providing voice and/or data communications, such as a cellular network, a PCS network, etc. Coverage area 100 includes base stations 104 and 106 of the wireless network for transmitting content to a plurality of users located within one or more service zones 1-25.

According to one embodiment of the invention, coverage area 100 is divided into a plurality of service zones 1-25. Service zones 1-25 are defined for providing location-based services where users within a particular service zone 1-25 receive the same location-based services content. Because users within the boundaries of a service zone are “approximately” at the same location, the users may share content instead of providing each user with individualized content. Content of the location-based service may include traffic reports, weather reports, advertisements, local attractions, other users located within the service zone, etc.

As shown in FIG. 1, service zones 1-25 are divided into approximately rectangular areas within a coverage area 100. However, service zones may be defined as any size or shape for providing appropriate boundaries for providing location-based services. Service zones 1-25 may be defined to match available processing, memory and bandwidth increments of coverage area 100 with expected user density. Service zones 1-25 may also be defined to provide optimal location-based services to users. Service zones 1-25 may also be defined based on geographical and geological conditions, such as building density, natural terrain and radio signal activity. Thus, in a densely populated city, service zones 1-25 may be the size of one or more city blocks. However, in less densely populated areas, service zones 1-25 may be larger in size (e.g., several square miles or more).

As illustrated in FIG. 1, base stations 104 and 106 each serve a plurality of service zones. However, those of ordinary skill in the art will recognize that depending on the size of the defined service zones 1-25, abase station (e.g., base station 104) may serve a single service zone, or a single service zone may be served by a plurality of base stations (e.g., base stations 104 and 106).

FIG. 2 illustrates service zone 7 of coverage area 100 of FIG. 1 in an exemplary embodiment of the invention. Service zone 7 includes a plurality of users 201-204 located within the boundaries of service zone 7. Each user 201-204 operates a communication device (not shown) to communicate with base station 104. A communication device comprises any device or system configured to communicate via wireless signals, such as a cell phone, a PDA, etc.

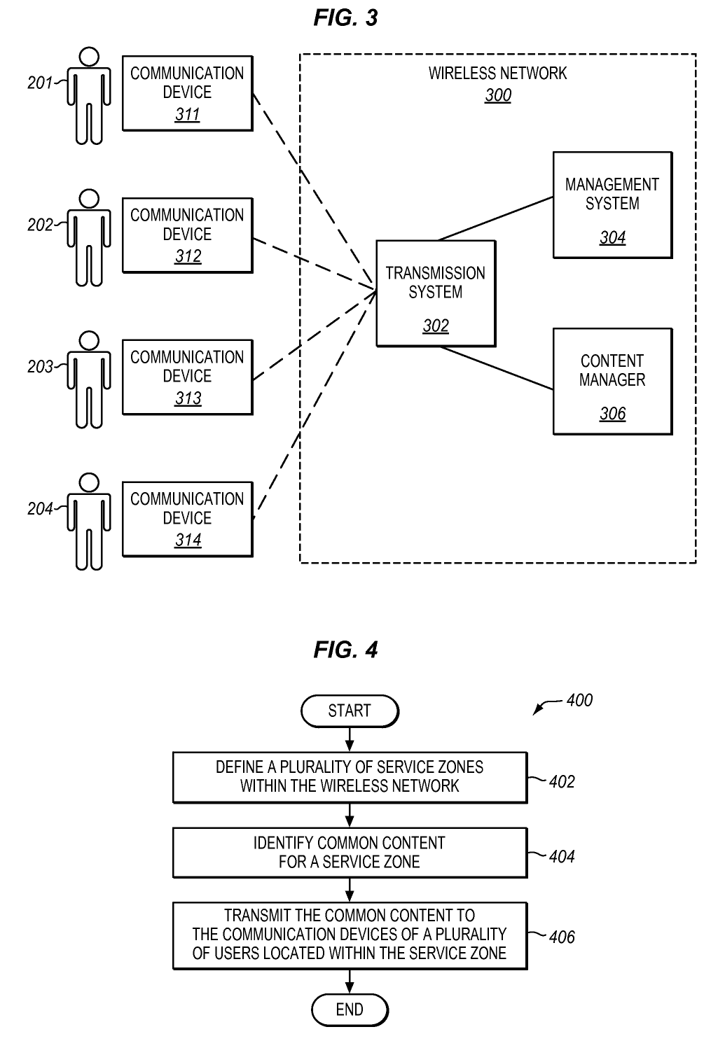

FIG. 3 illustrates a wireless network 300 for providing location-based services in an exemplary embodiment of the invention. Wireless network 300 may include service zones 1-25 of coverage area 100 illustrated in FIG. 1. Wireless network 300 comprises a management system 304 adapted to define and manage a plurality of service zones (e.g., service zones 1-25 of FIG. 1).

Wireless network 300 further comprises content manager 306 adapted to identify or generate common content for a service zone (e.g., service zone 7). Common content is information relating to a service zone that is provided to one or more users within the service zone. Content manager 306 may generate the common content, or may aggregate the common content from other sources. Common content may include information for each service zone 1-25, such as traffic reports, weather reports, emergency services (police, fire and medical), chat rooms, restaurants, hotels, gas stations, etc. For example, content manager 306 may generate traffic reports for a service zone based on information provided by users of wireless network 300. Content manager 306 may also identify advertisements specifically tailored to a particular service zone (e.g., service zone 7), such as a special lodging rate for the evening for a hotel located within the service zone. Content manager 306 may also aggregate user information maintained by management system 304. User information may include users which are businesses or service providers (such as police men in cruisers or taxi drivers). Management system 304 may provide content manager 306 with the user information for inclusion in the common content.

Wireless network 300 further comprises transmission system 302 adapted to transmit the common content to a plurality of users (e.g., users 201-204) located within a service zone (e.g., service zone 7). Transmission system 302 may also be adapted to receive information from users, such as connection requests, dynamic location information, location updates, etc. Transmission system 302 may include one or more base stations (e.g., base station 104 or 106 of FIG. 1), a Mobile Switching Center (MSC) (not shown), and/or one or more other network nodes (not shown). Transmission system 302 is configured to provide wireless service to a plurality of communication devices 311-314. Transmission system 302 may communicate with communication devices 311-314 using Code Division Multiple Access (CDMA), Time Division Multiple Access (TDMA), Global System for Mobile Communication (GSM), Universal Mobile Telecommunications System (UMTS), 802.11 WiFi, BlueTooth (Registered), satellite, packet radio, or any other wireless protocol.

As shown in FIG. 2, users 201-204 are located within the same service zone (e.g., service zone 7). Because users 201-204 are located in approximately the same geographic location, wireless network 300 may provide users 201-204 with the same common content defined for service zone 7. Thus, wireless network 300 does not need to identify individual content for each user 201-204 and transmit the individualized content to each of the users 201-204.

The users within a particular service zone receive the same common content. Communication devices 311-314 of the users may then be adapted to display relevant portions of the common content to users 201-204. For example, users may fine-tune the display of the common content utilizing filters on their communication device. Such filters may include a user selected display radius or other profile characteristics. For example, a user may only want to see hotels located with in a quarter mile radius of their present location, or may only want to see five star hotels.

FIG. 4 is a flow chart illustrating a method 400 of operating a wireless network to provide location-based services in an exemplary embodiment of the invention. The steps of method 400 will be described with reference to wireless network 300 in FIG. 3. The steps of the flow chart in FIG. 4 are not all-inclusive and may include other steps not shown.

In step 402, a plurality of service zones (e.g., service zones 1-25 of FIG. 1) are defined within the coverage area 100 of wireless network 300. The service zones are defined for providing location-based services to users (e.g., users 201-204) located within the boundaries of service zones 1-25. An operator of wireless network 300 may manually define the boundaries of the service zones 1-25. Alternatively, management system 304 may include software to optimally determine the boundaries of service zones 1-25 based on various factors. These factors may include geographic limitations, network limitations, expected user densities, etc.

In step 404, content manager 306 identifies common content for at least one of the service zones 1-25. For example, content manager 306 may identify traffic and weather reports for a service zone (e.g., service zone 7) provided by third party providers, such as a local news outlet. Content manager 306 may also identify coupons or advertisements related to the service zone, such as dinner specials for a local restaurant or a lodging discount for a local hotel. The common content may further include static location information available for the service zone, such as emergency numbers, links to local web sites, links to specific services (e.g., forms for reporting accidents and traffic problems), etc. Content manager 306 aggregates the content identified for the service zone and generates common content for the service zone. Content manager 306 may identify common content for each of service zones 1-25.

In step 406, transmission system 302 transmits the common content to communication devices (e.g., communication devices 311-314) of users 201-204 located within the service zone. Transmission system 302 may broadcast the common content within the service zone. The common content may comprise one or more files or packets when transmitted to users 201-204.

Common content may be repeatedly refreshed or updated at specified intervals to ensure that the common content is up-to-date. For example, content manager 306 may identify updated common content every 15 minutes, and transmission system 302 may then transmit the common content to the users (e.g., users 201-204) located within the service zone. Updating the common content may also ensure that users entering a service zone receive the common content within a reasonable period of time after entering the service zone.

Communication devices (e.g., communication devices 311-314) of the users receive the same common content. Responsive to receiving the common content, the communication devices may process the common content for appropriate display to users.

A communication device may include a location-based services browser for parsing the common content and displaying portions of the common content in appropriate locations within the browser. For example, a browser may include tabs for traffic reports, weather reports, restaurants, local attractions, lodging, taxis, bus and train schedules, emergency numbers, news, etc. Tabs within the browser may also display common content for a service zone which may be of a type not available in all service zones. For example, if the service zone includes an airport, then the common content may include flight arrival and departure times, baggage claim information, rental car and shuttle bus information, and other information specific to the airport.

The common content may include information used by communication devices 311-314 to filter the common content and display portions of the common content to a user of the communication device. Filtering may be done based on user or network-defined criteria. Such criteria may be entered at the time of display of the common content, or may be predefined on the communication device. For example, if the common content includes flight arrival and departure times, then a user may use information within the common content to filter the common content to a specific airline. Alternatively, if the common content includes a list of local restaurants, then the information may include cuisine types for the restaurants. A user (e.g., user 201) looking for an Italian restaurant may then use menus within the browser on their communication device (e.g., communication device 311) to narrow the list of restaurants to those serving Italian cuisine.

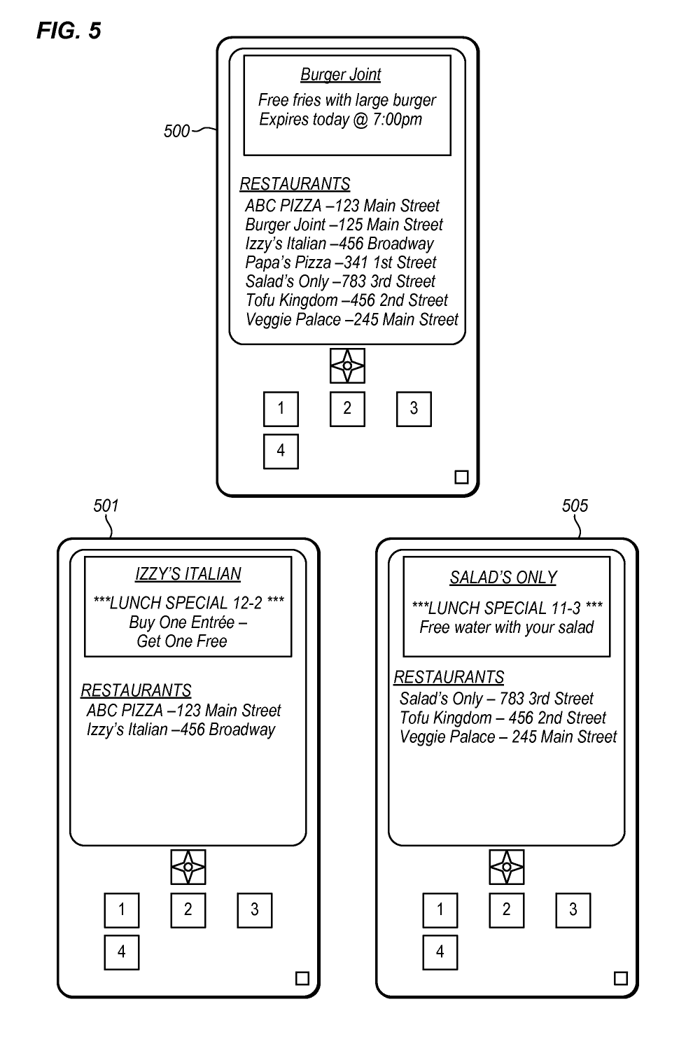

FIG. 5 illustrates communication devices 500, 501 and 505 displaying common content (both filtered and unfiltered) in an exemplary embodiment of the invention. Communication devices 500, 501 and 505 are adapted to filter and display the common content provided by wireless network 300 (see FIG. 3). All three communication devices 500, 501 and 505 receive the same common content from transmission system 302 for the same service zone where the users of communication devices 500, 501 and 505 are located. Users of communication devices 500, 501 and 505 may then filter the common content to display relevant portions of the common content that each user desires to see.

Assume for example that the common content received by communication devices 500, 501 and 505 includes a list of restaurants located within the service zone. Communication device 500 illustrates the common content in unfiltered form. Specifically, communication device 500 displays all restaurants within the immediate vicinity and also displays an advertisement for a special at one of the restaurants.

A user may want to filter the common content when it is displayed on the user's communication device based on user defined criteria. For example, a user may want to see a list of Italian restaurants within the service zone. Communication device 501 illustrates a scenario where communication device 501 has filtered the common content to display a list of Italian restaurants in the service zone based on information provided by a user. Communication device 501 also displays an advertisement for one of the Italian restaurants.

A user may also statically define a particular type of restaurant they want automatically displayed on their communication device. For example, a vegetarian may only want to see restaurants that serve vegetarian meals. Communication device 505 illustrates a scenario where communication device 505 has filtered the common content to display a list of vegetarian restaurants in the service zone based on predefined criteria stored within communication device 505. Communication device 505 also displays an advertisement for one of the vegetarian restaurants.

Thus, while communication devices 500, 501 and 505 receive corresponding common content, a user of a communication device may filter the common content to display relevant portions of the common content that the user desires to see. Wireless network 300 no longer needs to determine individualized content for each user of the network. Rather, the network may generate common content for a service zone, and communication devices (e.g., communication devices 311-314) may then be adapted to display relevant portions of the common content to users (e.g., users 201-204).

In other embodiments, filtering may be done based on other characteristics of the users, such as a level of service of the user. For example, the wireless network may offer different levels of service that allow users to view different types of content on their communication device. Each communication device may store a level of service that is used to filter the common content. Portions of the common content may be tagged with attributes indicating that the information be displayed to a user having a particular level of service, but should be excluded for users not having the particular level of service. The communication devices may then display the portions of the common content that a user is authorized to view based on the user's level of service.

Because users (e.g., users 201-204) located within a service zone (e.g., service zone 7) receive the same common content, transmission system 302 may broadcast the common content within the service zone. If a single base station 104 (see FIG. 1) of transmission system 302 serves multiple service zones (e.g., service zones 1-25), then scrambling codes may be used to encode the common content for a specified service zone (e.g., service zone 7).

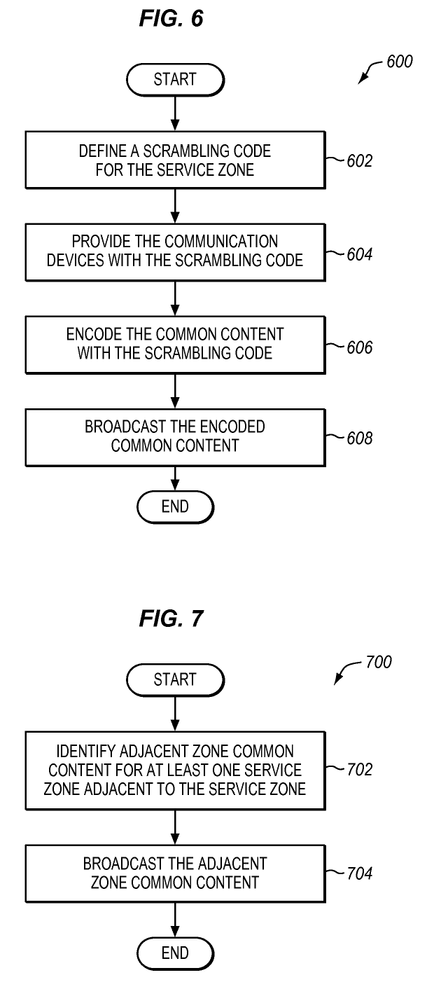

FIG. 6 is a flow chart illustrating another method 600 of operating a wireless network to provide location-based services using scrambling codes in an exemplary embodiment of the invention. The steps of method 600 will be described with reference to wireless network 300 in FIG. 3. The steps of the flow chart in FIG. 6 are not all inclusive and may include other steps not shown.

In step 602, management system 304 defines a scrambling code for a service zone. A scrambling code is used to decode an encrypted datastream (e.g., the encrypted common content) intended for a communication device 311-314. A user (and their associated communication device) may be authorized to view the common content for the service zone they are located within, but may not be authorized to view common content for other service zones (e.g., an adjacent service zone).

In step 604, transmission system 302 transmits the scrambling code to communication devices 311-314 of users 201-204. The scrambling code may be initially provided when a user registers with wireless network 300 based on the initial location of the user. Scrambling codes may be updated during a handshake between a communication device of the user and management system 304. As a communication device moves between service zones, the communication device may be provided with a new scrambling code for the new service zone location of the communication device.

The management system 304 may be adapted to determine and/or track a specific service zone where a particular user is located within (e.g., users 201-204 within service zone 7) to provide the user with the appropriate scrambling code for the service zone. By determining the coordinates of a user, management system 304 may determine the specific service zone location of the user. The specific service zone location of the user is then used to determine the appropriate service zone common content to provide the user and may also be provided to content manager 302 for inclusion in the common content. For example, assume that management system 304 determines the latitude and longitude of user 201. The latitude and longitude of user 201 may be determined through assisted GPS of a communication device 311 operated by user 201. By comparing the latitude and longitude of user 201 with known service zones, management system 304 may determine the specific service zone where user 201 is located (e.g., service zone 7). Thus, components of wireless network 300 may then determine the scrambling code that is transmitted to communication device 311 of user 201.

In step 606, transmission system 302 encodes the common content with the scrambling code. In step 608, transmission system 304 broadcasts the encoded common content within the service zone for receipt by communication devices 311-314 of users 201-204. Communication devices 311-314 apply the scrambling code to decode the common content for display to users 201-204.

One issue with location-based services arises when a user is traveling between service zones. While wireless network 300 may provide common content for the service zone that the user is located within, that common content may not be relevant to the user. Rather, the user may desire to see common content for an adjacent service zone that the user will be arriving within during a short period of time thereafter. For example, assume a user traveling along the interstate desires to see lodging located within an adjacent service zone. The user may desire to see this information without making a request to wireless network 300. However, to push the desired information to this user, wireless network 300 would need to determine the present location and direction of travel for this user to determine what adjacent service zone content to push to the user. This processing may place a strain on wireless network 300. If wireless network 300 needs to determine the relevant content on a user by user basis, then many of the advantages of using service zones to provide common content to a plurality of users are negated.

One solution to this problem is to provide a user with the common content for the service zone they are located within, as well as common content for one or more adjacent service zones. The browser on the user's communication device may then be adapted to allow the user to display the relevant information for the service zone that they desire to see.

FIG. 7 is a flow chart illustrating a method 700 of operating a wireless network to provide location-based services in an exemplary embodiment of the invention. The steps of method 700 will be described with reference to wireless network 300 in FIG. 3. The steps of the flow chart in FIG. 7 are not all inclusive and may include other steps not shown.

In step 702, content manager 306 identifies adjacent zone common content for one or more service zones that are adjacent to the service zone where the user is located. For example, referring to FIG. 1, if the user is located within service zone 7, then service zone 7 has adjacent service zones 1-3, 6, 8 and 11-13. The adjacent zone common content may be identified in the same manner as the common content for the service zone as discussed above in step 402 of FIG. 4.

In step 704, transmission system 302 broadcasts the adjacent zone common content (e.g., content for service zone 6) to the users within the service zone (e.g., service zone 7). The adjacent zone common content may be available for immediate display to a user, or the communication device may be adapted to display the adjacent zone common content to the user when the communication device enters the adjacent service zone.

Those of ordinary skill in the art may recognize that adjacent zone common content may be encoded with scrambling codes for broadcast to users 201-204. The adjacent zone common content may be encoded with the same scrambling code as the common content for service zone 7. Likewise, the adjacent zone common content may be encoded with a different scrambling code than the scrambling code for the common content of service zone 7. Transmission system 302 may provide communication devices 311-314 with the scrambling codes for the adjacent service zones. The scrambling codes for the adjacent service zones may be provided to communication devices 311-314 during a handshake when communication devices 311-314 are provided with the scrambling code for the service zone where communication devices 311-314 are presently located. Thus, communication devices 311-314 may use multiple scrambling codes to receive common content for a plurality of service zones. As a user moves between service zones, the adjacent service zones may likely change, and the communication device of the user may be provided with new scrambling codes for the newly adjacent service zones.

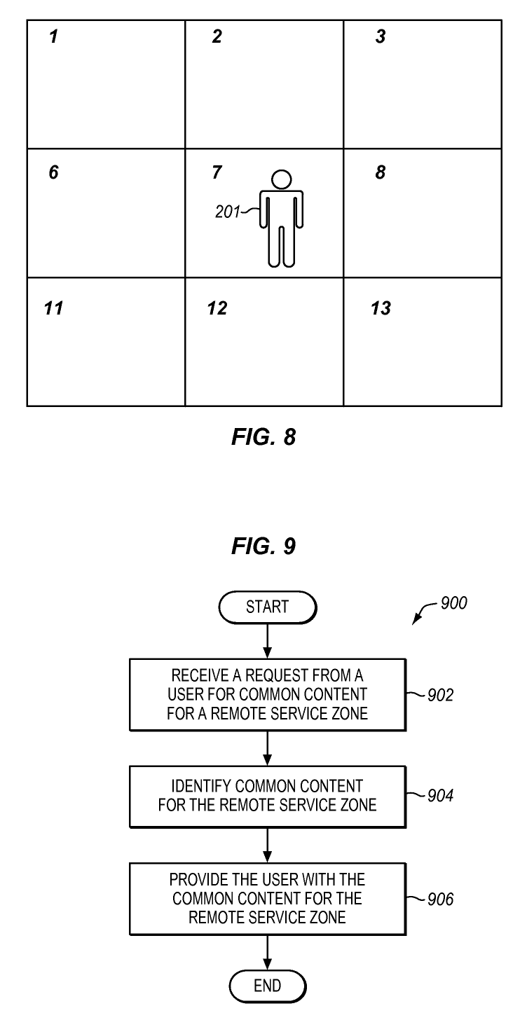

FIG. 8 illustrates a user 201 located within service zone 7 of coverage area 100. Service zone 7 has eight adjacent service zones (i.e., service zones 1-3, 6, 8 and 11-13). User 201 may receive common content for each of service zones 1-3, 6-8 and 11-13 rather than just service zone 7.

To facilitate efficient transmission of common content for a plurality of service zones 1-25, base station 104 may be adapted to transmit common content for any of the service zones 1-25 located within the service radius of base station 104 (i.e., service zones 1-3, 6-8, 11-13, 16-18 and 21-23). A communication device of a user (e.g., user 201) may then receive nine scrambling codes, one scrambling code representing the service zone that the communication device is located within (e.g., service zone 7), and eight scrambling codes for the adjacent service zones (e.g., service zones 1-3, 6, 8, and 11-13). The communication device may then apply the scrambling codes to the broadcast of information from base station 104 to determine the common content for the nine service zones that is applicable to the communication device.

This provides significant bandwidth savings for base station 104, because common content transmitted for a particular service zone may represent the common content for the service zone where one group of users is presently located, and may also represent adjacent zone common content for a different group of users. Base station 104 thus only needs to broadcast the common content for each service zone once, and any communication device located within the service radius of base station 104 may receive the common content if the common content is applicable to the communication device.

Wireless network 300 may also be adapted to allow a user to request content for a remote service zone. FIG. 9 is a flow chart illustrating a method 900 of operating a wireless network to provide location-based services in an exemplary embodiment of the invention. The steps of method 900 will be described with reference to wireless network 300 in FIG. 3. The steps of the flow chart in FIG. 9 are not all-inclusive and may include other steps not shown.

In step 902, content manager 306 receives a request from a user (e.g., user 201) for common content for a remote service zone. For example, the browser operating on the communication device (e.g., communication device 311) of the user may display a map to the user, and the map may allow the user to select the desired remote service zone.

In step 904, content manager 306 identifies the common content for the remote service zone. In step 906, transmission system 302 transmits the common content for the remote service zone to the user. The retrieval of the remote service zone common content of a user may be a pull-based operation, so as not to waste valuable network resources updating the remote service zone common content when updates may not be needed.

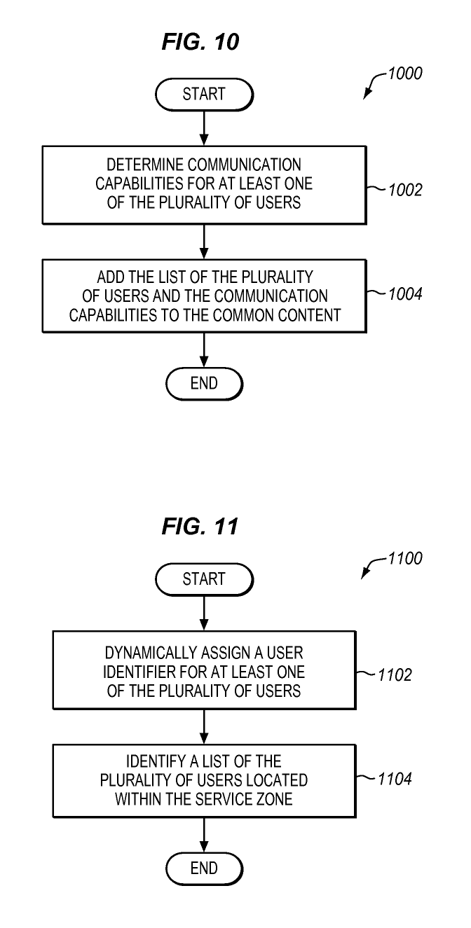

One particular component of common content may include a list of users located within the service zone so that a user may initiate communication with one or more of the users. FIG. 10 is a flow chart illustrating a method 1000 of operating a wireless network to provide location-based services in an exemplary embodiment of the invention. The steps of method 1000 will be described with reference to wireless network 300 in FIG. 3. The steps of the flow chart in FIG. 10 are not all-inclusive and may include other steps not shown.

In step 1002, content manager 306 determines the communication capabilities for the users. Communication capabilities are means through which one user may communicate with another user, such as by phone, text message, email, instant message, etc. For example, content manager 306 may determine that user 201 is available via phone, text message, instant message and email, that user 202 is available for communication via phone, text message and instant message, that user 203 is available for communication via instant message and email, and that user 204 is available for communication via phone and text message.

In step 1004, content manager 306 adds the list of the users and the communication capabilities of the users to the common content. The common content is then transmitted to the users and may be displayed by a communication device (see communication device 1110 of FIG. 11). One of the users may then use the list to initiate communication with another one of the users.

A user may then determine the other users that are in his/her vicinity, and how to communicate with those other users. The requesting user does not need to maintain a buddy list to receive the service, as wireless network 300 or the communication device automatically determines what other users are in the geographic area and indicates those other users to the user. The location-based service expands the number of individuals the user can communicate with, even to individuals for which the user did not previously know their phone number, email address, webpage, etc.

Protection of user's personal information is an important concern. Some users may not desire for their personal information (e.g., telephone number, email address, etc.) to be provided to a group of users of wireless network 300. Thus, dynamically assigned aliases may be used to protect personal information of users. FIG. 11 is a flow chart illustrating a method 1100 of operating a wireless network to provide location-based services in an exemplary embodiment of the invention. The steps of method 1100 will be described with reference to wireless network 300 in FIG. 3. The steps of the flow chart in FIG. 11 are not all inclusive and may include other steps not shown.

In step 1102, management system 304 dynamically assigns a user identifier for one or more of users 201-204. The user identifier may be dynamically assigned when a user registers with wireless network 300, or may be periodically dynamically assigned by management system 304 at specified times (e.g., when a user powers off their communication device). A user identifier is embedded within the common content and is an alias for a user (e.g., user 201) so that the user's personal information (e.g., phone number, email address, etc.) may be kept hidden from other users (e.g., user 202). However, other users may still initiate communication with the user through the user identifier. Thus, user 202 may see user 201 listed in the common content as available for communication, and initiate communication (e.g., a phone call or text message) without knowing the phone number of user 201. Because the user identifier is dynamically assigned to user 201, user 202 may not be able to initiate communication with user 201 through the same user identifier after user 201 powers off and powers back on their communication device 311 and wireless network 300 assigns a new user identifier for user 201.

In step 1104, content manager 304 identifies a list of the users located within the service zone. This list may include the user identifier for each of the users. For example, in service zone 7 illustrated in FIG. 2, content manager 306 may identify the four users present within service zone 7. An exemplary identified list is illustrated below.

| User Identifier | User |
|---|---|
| user1038 | User 201 (Designated as User A) |
| user3737 | User 202 (Designated as User B) |
| user9493 | User 203 (Designated as User C) |
| user4745 | User 204 (Designated as User D) |

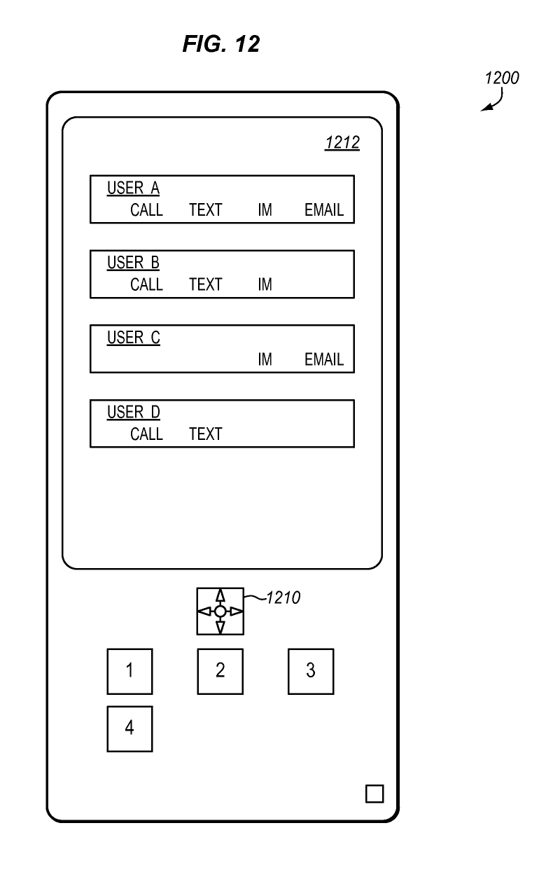

FIG. 12 illustrates a communication device 1200 in an exemplary embodiment of the invention. Communication device 1200 is adapted to display common content provided by wireless network 300. As illustrated, communication device 1200 displays the list of the plurality of users and the communication capabilities included in the common content. Common content may also contain common services specific to the service zone, such as a common service zone chat room, RSS messages, traffic & weather, etc.

Assume that user 201 of communication device 1200 views the list, and sees that user 204 (designated as User A) is in the same service zone, and thus, in approximately the same geographical location. User 201 may decide to initiate a call to user 204 (designated as User D). The list may allow user 201 to initiate a phone call-to user 204 without knowing his or her phone number. By selecting the phone option next to user 204, user 201 may initiate a phone call to user 204. To initiate the call, user 201 uses direction pad 1210 to select the desired user 204 and communication option. The user identifier of user 204 may then be transmitted by communication device 1200 to a switching system (e.g., an MSC) of wireless network 300. The switching system may use the user identifier of user 204 (e.g., “user4745”) to determine stored information associated with user 204, such as the phone number of user 204 to route the call. Because a user identifier is dynamically assigned, user 201 may be unable to initiate a phone call to user 204 using the user identifier “user4745” at a later date.

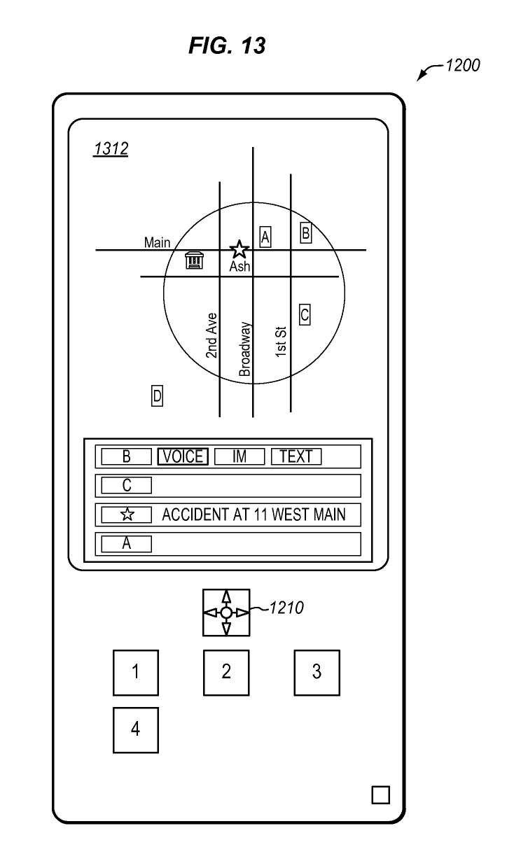

FIG. 13 illustrates a communication device 1200 in an exemplary embodiment of the invention. As illustrated, communication device 1200 displays a map 1312 of the service zone (e.g., service zone 7 of FIG. 2) where a user 201 of the communication device 1200 is located. Map 1312 includes a traffic report as well as the locations of the other users (e.g., users 202, 203 and 204) located within the service zone. Like in FIG. 12, user 201 may initiate communication with another user located within the service zone. User 201 may use direction pad 1210 to select the desired user 204 and communication option to initiate the communication.

A wireless network (e.g., wireless network 300 of FIG. 3) may not provide location-based services in every service zone defined within the wireless network. For example, there may be a lack of location-based services to provide within a service zone, or the service zone may be too sparsely populated, and thus offering location-based services may be undesirable. In other instances, a service zone may be populated at only particular times of the day or year, and therefore it may be desirable to offer location-based services only during particular times of the day or year. Thus, a wireless network may determine which of the service zones to provide location-based services at any particular time.

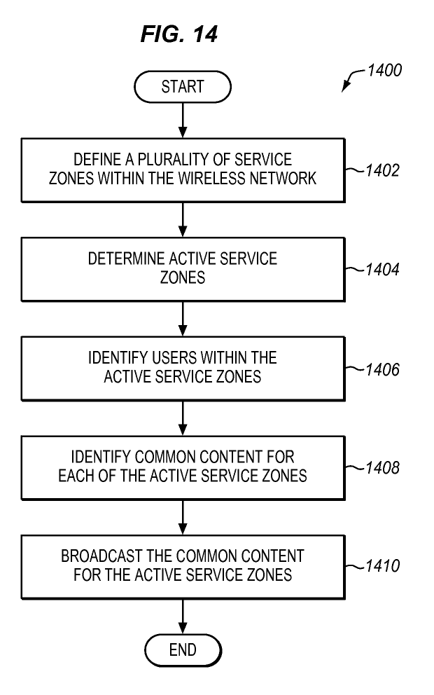

FIG. 14 is a flow chart illustrating a method 1400 of operating a wireless network to provide location-based services in an exemplary embodiment of the invention. The steps of method 1400 will be described with reference to wireless network 300 in FIG. 3. The steps of the flow chart in FIG. 14 are not all inclusive and may include other steps not shown.

In step 1402, management system 304 defines a plurality of service zones (e.g., service zones 1-25 of FIG. 1) within wireless network 300. The service zones are defined for providing location-based services to users (e.g., users 201-204) located within the boundaries of the service zones.

In step 1404, management system 304 determines active service zones for providing location-based services. Active services zones may be determined by selecting one or more of the service zones of wireless network 300 that include users located within the service zone. For example, if a service zone does not include any users, then the service zone may not be designated as an active service zone at the present time.

In step 1406, management system 304 identifies users within the active service zones. Management system 304 may determine the coordinates (e.g., latitude and longitude) of a user (e.g., user 201) via transmission system 302 and translate the coordinates into the corresponding service zone location (e.g., service zone 7) of the user. By determining the corresponding service zone location of each user of wireless network 300, management system 304 may group users together by service zone.

In step 1408, content manager 304 identifies common content for each of the active service zones. The common content for one or more of the active service zones may include a list of the users located within each of the active service zones. Thus, as part of the common content, each user may receive a corresponding list of users located within the same service zone, and may be able to initiate communication with these users.

In step 1410, transmission system 302 broadcasts the common content for the active service zones to the groups of users. The common content for the active service zones may be broadcast using scrambling codes as discussed above. Thus, a particular group of users for a particular service zone may be provided with common content for the service zone, while another group of users for another service zone may be provided with common content for their corresponding service zone.

Although specific embodiments were described herein, the scope of the invention is not limited to those specific embodiments. The scope of the invention is defined by the following claims and any equivalents thereof.

We claim:

1. A system for providing location-based services on a wireless network, the system comprising:
a management system adapted to define a plurality of service zones within the wireless network, wherein the service zones are defined for providing location-based services to users within the service zones;
a content manager coupled to the management system adapted to identify common content for a service zone; and
a transmission system coupled to the content manager adapted to transmit the common content to communication devices of a plurality of users located within the service zone.

2. The system of claim 1 wherein the common content comprises attributes used by the communication devices to filter the common content to determine a portion of the common content to display to a user of a communication device.

3. The system of claim 1 wherein the transmission system is further adapted to broadcast the common content within the service zone.

4. The system of claim 1 wherein the transmission system is further adapted to:
define a scrambling code for the service zone, wherein the scrambling code is used by a communication device of a user to decode the common content intended for the communication device;
transmit the scrambling code to the communication devices;
encode the common content with the scrambling code; and
broadcast the encoded common content within the service zone.

5. The system of claim 1 wherein:
the content manager is further adapted to identify adjacent zone common content for at least one service zone adjacent to the service zone that includes the plurality of users; and
the transmission system is further adapted to transmit the adjacent zone common content to the plurality of users.

6. The system of claim 5 wherein the transmission system is further adapted to:
define a first scrambling code for the common content of the service zone and define a second scrambling code for the adjacent zone common content of the adjacent service zone, wherein the first and second scrambling codes are used by a communication device of a user to decode the common content and the adjacent zone common content intended for the communication device;
transmit the first and second scrambling codes to the communication devices;
encode the common content of the service zone with the first scrambling code;
encode the adjacent zone common content of the adjacent service zone with the second scrambling code; and
broadcast the encoded common content and the encoded adjacent zone common content within the service zone.

7. The system of claim 1 wherein the content manager is further adapted to:
identify a list of the plurality of users located within the service zone;
determine communication capabilities for at least one of the plurality of users; and
add the list of the plurality of users and the communication capabilities to the common content.

8. The system of claim 7 wherein the list comprises a user identifier for at least one of the plurality of users, and wherein the management system is further adapted to dynamically assign the user identifier for the at least one of the plurality of users to protect personal information of the at least one of the plurality of users.

9. The system of claim 1 wherein:
the content manager is further adapted to receive a request from a user for common content for a remote service zone and to identify the common content for the remote service zone; and
the transmission system is further adapted to transmit the common content for the remote service zone to a communication device of the user.

10. A method for providing location-based services on a wireless network, the method comprising:
defining a plurality of service zones within the wireless network, wherein the service zones are defined for providing location-based services to users within the service zones;
identifying common content for a service zone; and
transmitting the common content to communication devices of a plurality of users located within the service zone.

11. The method of claim 10 wherein the common content comprises attributes used by the communication devices to filter the common content to determine a portion of the common content to display to a user of a communication device.

12. The method of claim 10 wherein transmitting the common content further comprises:
broadcasting the common content within the service zone.

13. The method of claim 10 further comprising:
defining a scrambling code for the service zone, wherein the scrambling code is used by a communication device of a user to decode the common content intended for the communication device;
transmitting the scrambling code to the communication devices;
encoding the common content with the scrambling code; and
broadcasting the encoded common content within the service zone.

14. The method of claim 10 further comprising:
identifying adjacent zone common content for at least one service zone adjacent to the service zone that includes the plurality of users; and
transmitting the adjacent zone common content to the plurality of users.

15. The method of claim 14 further comprising:
defining a first scrambling code for the common content of the service zone and a second scrambling code for the adjacent zone common content of the adjacent service zone, wherein the first and second scrambling codes are used by a communication device of a user to decode the common content and the adjacent zone common content intended for the communication device;
transmitting the first and second scrambling codes to the communication devices;
encoding the common content of the service zone with the first scrambling code;
encoding the adjacent zone common content of the adjacent service zone with the second scrambling code; and
broadcasting the encoded common content and the encoded adjacent zone common content within the service zone.

16. The method of claim 10 further comprising:
identifying a list of the plurality of users located within the service zone;
determining communication capabilities for at least one of the plurality of users; and
adding the list of the plurality of users and the communication capabilities to the common content.

17. The method of claim 16 wherein the list comprises a user identifier for at least one of the plurality of users, and wherein the method further comprises:
dynamically assigning the user identifier for the at least one of the plurality of users to protect personal information of the at least one of the plurality of users.

18. The method of claim 10 further comprising:
receiving a request from a user for common content for a remote service zone;
identifying the common content for the remote service zone; and
transmitting the common content for the remote service zone to the user.

19. A method for providing location-based services on a wireless network, the method comprising:
defining a plurality of service zones within the wireless network, wherein the service zones are defined for providing location-based services to users within the service zones;
determining active service zones to provide location-based services that include users located within the service zone that are provided with location-based services for the service zone;
identifying the users within each of the active service zones;
generating common content for each of the active service zones, wherein the common content for at least one of active service zone comprises information of the users located with the at least one active service zone; and
broadcasting the common content for each the active service zones.

20. The method of claim 19 further comprising:
defining a scrambling code for each of the active service zones, wherein the scrambling code is used by a communication device of a user to decode the common content intended for the communication device;
transmitting the scrambling code for decoding common content for a service zone to communication devices of the users for each of the active service zones; and
encoding the common content for the active service zones with the corresponding scrambling code for each of the active service zones.
